(19) United States
(12) Patent Application Publication
(10) Pub. No.: US 2021/0304650 A1
(43) Pub. Date: Sep. 30, 2021

(54) IMAGE DISPLAY DEVICE AND IMAGE DISPLAY METHOD

(71) Applicant: Sharp NEC Display Solutions, Ltd., Tokyo (JP)

(72) Inventor: Kenji YAMAMOTO, Tokyo (JP)

(21) Appl. No.: 17/266,497

(22) PCT Filed: Aug. 9, 2018
(86) PCT No.: PCT/JP2018/029906

§ 371 Date: Feb. 5, 2021

(51) Int. Cl. G09G 3/00

(52) U.S. Cl. CPC G09G 3/007; G09G 2310/0286; G09G 2320/046

(57) ABSTRACT

An image display device includes: a display including a plurality of pixels; a selector configured to randomly select one or more pixels as target pixels from the plurality of pixels for each frame; and a target pixel value changer configured to change pixel values of one or more target pixels selected by the selector

### TECHNICAL FIELD

The present invention relates to an image display device and an image display method.

### BACKGROUND ART

In a personal computer (PC) display and the like, a screen saver is used to change normal image display to image display for the screen saver when there is no input for a predetermined time period. On the other hand, in an image display device used for surveillance purposes or digital signage (electronic signage), it is necessary to constantly display a normal image. Therefore, because it is unlikely for a screen saver for changing normal image display to image display for the screen saver to be used in the above-described image display device, there is a problem of burn-in after the use for a long time.

Also, as a method of saving the screen while displaying a normal image, a method of enlarging a display screen size and scrolling a display position in a figure-of-8 shape in a horizontal direction is conceivable. However, in the above-described method, an area where no change occurs is generated according to the displayed image and hence there is a problem that it is difficult to obtain the burn-in prevention effect. Also, because the entire screen moves, a sense of discomfort may be given to a viewer.

On the other hand, an example of a configuration of a screen saver by hardware is described in Patent Literature 1. In the image display device described in Patent Literature 1, two image signals having a time difference are compared and an image signal which is displayed is switched to an image signal subjected to an attenuation process when the two image signals are continuously the same for a certain period of time. In the image display device described in Patent Literature 1, a display state of the entire area of the screen or a part of the area having a certain size may change before and after the image signal is switched. Thus, there is a problem that a sense of discomfort may be given to the viewer.

### CITATION LIST

### Patent Literature

### [Patent Literature 1]

Japanese Unexamined Patent Application, First Publication No. H6-59656

### SUMMARY OF INVENTION

### Technical Problem

The present invention has been made in view of the above-described circumstances and an objective of the present invention is to provide an image display device and an image display method capable of preventing burn-in from occurring without giving a sense of discomfort to a viewer.

### Solution to Problem

To solve the above-described problem, one aspect of the present invention is an image display device including: a display unit including a plurality of pixels; a selection unit configured to randomly select one or more pixels as target pixels from the plurality of pixels for each frame; and a target pixel value change unit configured to change pixel values of one or more target pixels selected by the selection unit.

One aspect of the present invention is an image display method including: using a display unit including a plurality of pixels; randomly selecting, by a selection unit, one or more pixels as target pixels from the plurality of pixels for each frame; and changing, by a target pixel value change unit, pixel values of one or more target pixels selected by the selection unit.

### Advantageous Effects of Invention

According to the aspects of the present invention, it is possible to prevent burn-in from occurring without giving a sense of discomfort to a viewer.

### BRIEF DESCRIPTION OF DRAWINGS

FIG. 1 is a block diagram showing an example of a configuration of an image display device 1 according to an embodiment of the present invention.

FIG. 2 is a circuit diagram showing an example of a configuration of a linear feedback shift register 110 constituting a random number generation circuit 11 shown in FIG. 1.

FIG. 3 is a schematic diagram showing a video signal display unit 14 shown in FIG. 1.

FIG. 4 is a schematic diagram showing some of a plurality of pixels included in the video signal display unit 14 shown in FIG. 1.

FIG. 5 is a flowchart showing an example of an operation of the image display device 1 shown in FIG. 1.

FIG. 6 is a block diagram showing an example of a basic configuration of an image display device 2 according to an embodiment of the present invention.

### DESCRIPTION OF EMBODIMENTS

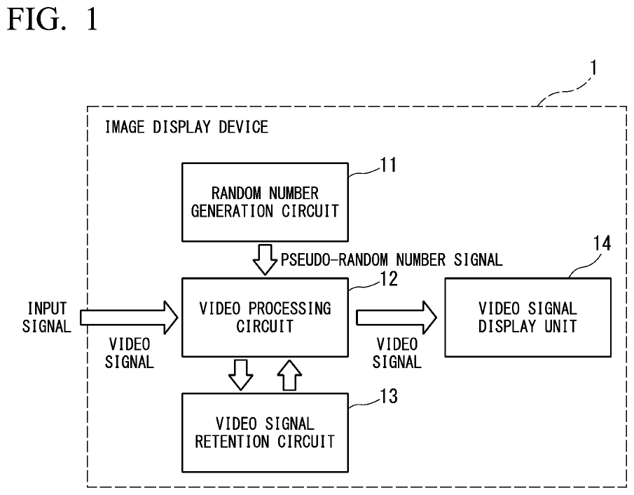

Hereinafter, embodiments of the present invention will be described with reference to the drawings. FIG. 1 is a block diagram showing an example of a configuration of an image display device 1 according to an embodiment of the present invention.

The image display device 1 shown in FIG. 1 is, for example, a display device such as a liquid crystal display or an organic electroluminescence (EL) display. Here, the image display device 1 may be a display device such as a projector. The image display device 1 shown in FIG. 1 includes a random number generation circuit 11, a video processing circuit 12, a video signal retention circuit 13, and a video signal display unit 14.

The video signal display unit 14 is, for example, a display panel such as a liquid crystal panel or an organic EL panel. The video signal display unit 14 has a plurality of pixels and displays an image based on a video signal by controlling the luminance of each pixel on the basis of a video signal output by the video processing circuit 12.

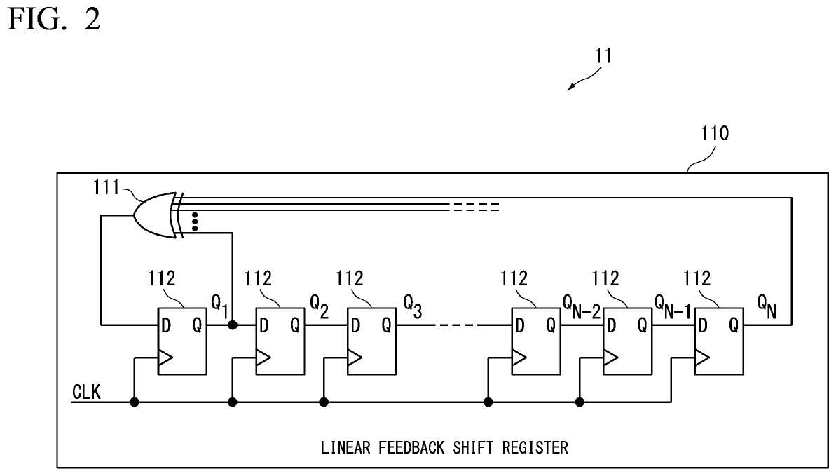

The random number generation circuit 11 is a circuit that generates a pseudo-random number signal. For example, the random number generation circuit 11 newly generates the pseudo-random number signal for each frame period of the video signal and outputs the generated pseudo-random number signal to the video processing circuit 12. The video processing circuit 12 randomly selects one or more pixels from a plurality of pixels provided in the video signal display unit 14 on the basis of the pseudo-random number signal generated by the random number generation circuit 11. For example, the random number generation circuit 11 can be configured using a linear feedback shift register 110 shown in FIG. 2.

FIG. 2 is a circuit diagram showing an example of a configuration of the linear feedback shift register 110 constituting the random number generation circuit 11 shown in FIG. 1. The linear feedback shift register (LFSR) 110 shown in FIG. 2 includes one multi-input exclusive OR circuit 111 and N (N-stage) D-type flip-flops 112 connected in series. A common clock signal CLK is input to clock inputs of the N D-type flip-flops 112. An output of the multi-input exclusive OR circuit 111 is input to an input (D) of a first-stage D-type flip-flop 112. An output (Q₁) of the first-stage D-type flip-flop 112 is input to an input (D) of a second-stage D-type flip-flop 112. An output (Q₂) of the second-stage D-type flip-flop 112 is input to an input (D) of a third-stage D-type flip-flop 112. Subsequently, likewise, for example, an output (Q_{N-1}) of an N−1^{th}-stage D-type flip-flop 112 is input to an input (D) of an N^{th}-stage D-type flip-flop 112. Also, a plurality of predetermined outputs (Q_{N}) of the N D-type flip-flops 112 are input to the multi-input exclusive OR circuit 111.

As described above, the video signal display unit 14 randomly selects one or more pixels on the basis of the pseudo-random number signal. At that time, if a maximum value of pseudo-random number signals (Q₁, Q₂, . . . , Q_{N}) output by the linear feedback shift register 110 is greater than or equal to the number of pixels of the video signal display unit 14, the video processing circuit 12 can randomly select any one pixel. For example, when the resolution of the video signal display unit 14 is the resolution of full HD (1920×1080), the number of pixels of the video signal display unit 14 is 2,073,600 (=1920×1080). In this case, the video processing circuit 12 can randomly select any one pixel by setting the number of stages N of the linear feedback shift register 110 to N=21 (2²¹=2,097,152).

Also, for example, the random number generation circuit 11 may be configured using a first linear feedback shift register 110 that outputs a pseudo-random number signal corresponding to horizontal resolution and a second linear feedback shift register 110 that outputs a pseudo-random number signal corresponding to vertical resolution. In this case, a horizontal position (a horizontal coordinate value) and a vertical position (a vertical coordinate value) can be directly designated by an output of each linear feedback shift register 110.

Next, the video signal retention circuit 13 shown in FIG. 1 is a frame memory or a line memory. The video signal retention circuit 13 retains a video signal input to the video processing circuit 12 as an input signal and a video signal processed by the video processing circuit 12 for one frame or one or more lines.

The video processing circuit 12 inputs the video signal as the input signal from outside and writes the input video signal to the video signal retention circuit 13. Also, the video processing circuit 12 reads the video signal written to the video signal retention circuit 13, performs predetermined image processing for each frame or each of the one or more lines, and rewrites the processed video signal to the video signal retention circuit 13. Also, the video processing circuit 12 reads a video signal from the video signal retention circuit 13 and outputs the video signal to the video signal display unit 14.

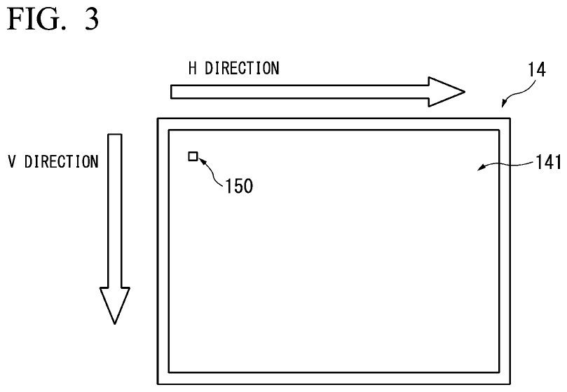

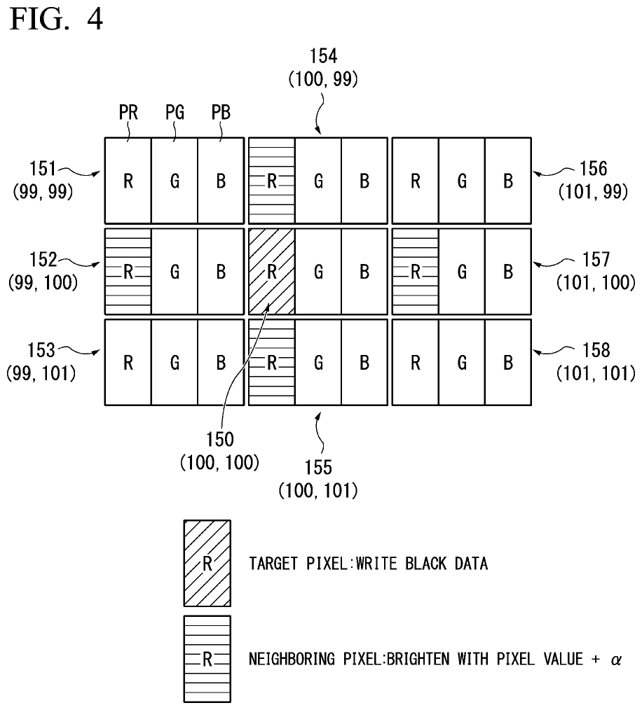

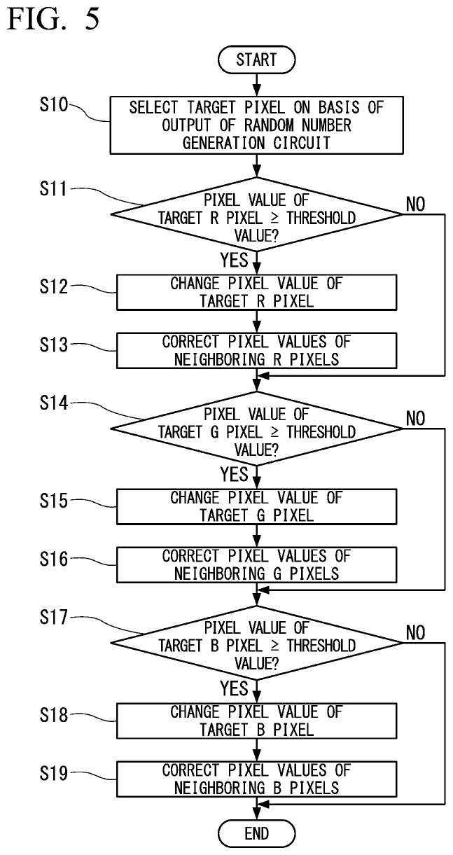

In addition to a process of preventing burn-in of the video signal display unit 14 (hereinafter referred to as a burn-in prevention process), for example, the predetermined image processing performed by the video processing circuit 12 includes a process of changing a color, luminance, a contrast ratio, resolution, and the like in all or part of the screen and the like. Hereinafter, an example of the burn-in prevention process performed by the video processing circuit 12 will be described with reference to FIGS. 3 to 5. FIG. 3 is a schematic diagram showing the video signal display unit 14 shown in FIG. 1. Also, FIG. 4 is a schematic diagram showing some of a plurality of pixels included in the video signal display unit 14 shown in FIG. 1. Also, FIG. 5 is a flowchart showing an example of an operation of the image display device 1 shown in FIG. 1.

As shown in FIG. 3, in the burn-in prevention process, for example, the video processing circuit 12 randomly selects one pixel 150 as a target pixel from a plurality of pixels constituting the screen 141 of the video signal display unit 14 and changes a pixel value (display data) to prevent burn-in. As described above, FIG. 3 schematically shows a relationship between the screen 141 of the video signal display unit 14 shown in FIG. 1 and the pixel 150, which is the target pixel.

Also, as shown in FIG. 4, in the burn-in prevention process, the video processing circuit 12 selects four pixels 152, 154, 155, and 157 above and below the pixel 150, which is the target pixel, and on the left and right of the pixel 150 as neighboring pixels and corrects pixel values of the four neighboring pixels. As described above, FIG. 4 schematically shows some (pixels 150 to 158) of the plurality of pixels provided in the video signal display unit 14 shown in FIG. 1. As shown in FIG. 4, each of the pixels 150 to 158 includes an R (red) pixel PR, a G (green) pixel PG, and a B (blue) pixel PB. The R pixel PR, the G pixel PG, and the B pixel PB are also referred to as sub-pixels of the pixels 150 to 158. The number of sub-pixels is not limited to three for RGB in total and may be four or more.

Also, in the example shown in FIG. 4, coordinates of the pixel 150, which is the target pixel, are (100, 100). A value of the coordinates is (horizontal coordinate value, vertical coordinate value). The horizontal coordinate value represents a position of the pixel in an H direction shown in FIG. 3 and the vertical coordinate value represents a position of the pixel in a V direction shown in FIG. 3. Also, in the example shown in FIG. 4, the coordinates of the four pixels 152, 154, 155 and 157, which are neighboring pixels, are (99, 100), (100, 99), (100, 101), and (101, 100).

Next, an example of the burn-in prevention process executed by the video processing circuit 12 will be described with reference to FIG. 5. FIG. 5 is a flowchart showing an example of a flow of the burn-in prevention process performed by the video processing circuit 12 shown in FIG. 1. Also, it is assumed that a pixel value of each pixel in the video signal is a value from “0” to “1023.” Also, the pixel value “0” is black data (minimum luminance).

The process shown in FIG. 5 is executed for each frame. When the process shown in FIG. 5 is executed, the video processing circuit 12 selects a target pixel on the basis of an output of the random number generation circuit 11 (step S10). In this example, it is assumed that the video processing circuit 12 selects the pixel 150 at coordinates (100, 100) shown in FIG. 4 as the target pixel.

Next, the video processing circuit 12 determines whether or not a pixel value of the R pixel PR (hereinafter referred to as a target R pixel) of the pixel 150, which is the target pixel, is greater than or equal to a predetermined threshold value (step S11). The threshold value is a reference value for determining whether or not to a pixel value change process is to be performed, for example, “512.”

When the pixel value of the target R pixel is greater than or equal to the threshold value (in the case of “YES” in step S11), the video processing circuit 12 changes the pixel value of the target R pixel (step S12). In step S12, the video processing circuit 12 prevents the burn-in of the target R pixel by changing the pixel value of the target R pixel in a decreasing direction. The video processing circuit 12 changes the pixel value, for example, by setting the pixel value to black data “0” or inverting the pixel value.

Next, the video processing circuit 12 corrects pixel values of the R pixels PR (hereinafter, referred to as neighboring R pixels) of the four pixels 152, 154, 155, and 157, which are pixels neighboring to the pixel 150, which is the target pixel (step S13). The correction of the pixel values with respect to the neighboring R pixels is performed to minimize deterioration in image quality due to the change in the pixel value of the target pixel. Although the display color changes when the pixel value of the target pixel is changed, ascertainment of a change due to the correction of the pixel values of the neighboring pixels can be difficult. Therefore, the video processing circuit 12 corrects the pixel values of the neighboring R pixels in an increasing direction by, for example, adding a predetermined value (a) to the pixel values of the neighboring R pixels. Even if the R pixel PR of a certain pixel becomes dark, it becomes difficult for the viewer to notice a change when viewed from a distance by brightening the neighboring pixels. Also, when the target pixel is located at an end of the screen, the number of pixels neighboring to the target pixel is two or three.

On the other hand, when the pixel value of the target R pixel is not greater than or equal to the threshold value (in the case of “NO” in step S11) or after step S13, the video processing circuit 12 determines that a pixel value of the G pixel PG (hereinafter referred to as a target G pixel) of the pixel 150, which is the target pixel, is greater than or equal to a predetermined threshold value (step S14). The threshold value may be the same as or different from the threshold value in step S11.

When the pixel value of the target G pixel is greater than or equal to the threshold value (in the case of “YES” in step S14), the video processing circuit 12 changes the pixel value of the target G pixel as in step S12 (step S15). In step S15, the video processing circuit 12 changes the pixel value of the target G pixel in the decreasing direction to prevent burn-in of the target G pixel.

Next, the video processing circuit 12 corrects pixel values of G pixels PG (hereinafter referred to as neighboring G pixels) of the four pixels 152, 154, 155 and 157 which are pixels neighboring to the pixel 150 which is the target pixel (step S16). In step S16, the video processing circuit 12 corrects the pixel values of the neighboring G pixels in the increasing direction by, for example, adding a predetermined value (a) to the pixel values of the neighboring G pixels.

On the other hand, when the pixel value of the target G pixel is not greater than or equal to the threshold value (in the case of “NO” in step S14) or after step S16, the video processing circuit 12 determines whether a pixel value of a B pixel PB (hereinafter referred to as a target B pixel) of the pixel 150 which is the target pixel is greater than or equal to a predetermined threshold value (step S17). The threshold value may be the same as or different from the threshold value in step S11 or the threshold value in step S14.

When a pixel value of the target B pixel is greater than or equal to the threshold value (in the case of “YES” in step S17), the video processing circuit 12 changes the pixel value of the target B pixel as in steps S12 and S15 (step S18). In step S18, the video processing circuit 12 changes the pixel value of the target B pixel in the decreasing direction to prevent burn-in of the target B pixel.

Next, the video processing circuit 12 corrects pixel values of B pixels PB (hereinafter referred to as neighboring B pixels) of the four pixels 152, 154, 155, and 157, which are pixels neighboring to the pixel 150, which is the target pixel (step S19). In step S19, the video processing circuit 12 corrects the pixel values of the neighboring B pixels in the increasing direction by, for example, adding a predetermined value (a) to the pixel values of the neighboring B pixels.

On the other hand, when the pixel value of the target B pixel is not greater than or equal to the threshold value (in the case of “NO” in step S17) or after step S19, the video processing circuit 12 ends the process shown in FIG. 5.

Also, the processing of step S10 is executed before a video signal of a new frame is retained in the video signal retention circuit 13 and the processing of steps S11 to S19 is executed in a state in which the pixel values of the target pixel selected in step S10 and the pixels neighboring to the target pixel have been retained in the video signal retention circuit 13.

In the process shown in FIG. 5, for example, when the pixel 150 at the coordinates (100, 100) is selected as the target pixel in step S10 and the pixel value of the target R pixel is greater than or equal to the threshold value and the pixel values of the target G pixel and the target B pixel are less than the threshold value, the pixel values of the target pixel and the neighboring pixels are written as follows. That is, as shown in FIG. 4, black data “0” is written to the target R pixel of the coordinates (100, 100) and pixel values obtained by adding a predetermined value “α” to the pixel values of the neighboring R pixels at the coordinates (99, 100), (100, 99), (100, 101), and (101, 100) are written. On the other hand, the pixel values of the target G pixel, the target B pixel, the neighboring G pixels, and the neighboring B pixels remain unchanged.

As described above, in the example of the operation shown in FIG. 5, one pixel is randomly selected as the target pixel from the plurality of pixels provided in the video signal display unit 14 for each frame (step S10). A pixel value of one selected target pixel is changed (step S12, S15, or S18). That is, according to the present embodiment, a change in pixel values for preventing the occurrence of burn-in is executed in units of pixels randomly selected for each frame. Therefore, according to the present embodiment, it is possible to prevent burn-in from occurring without giving a sense of discomfort to the viewer.

Also, according to the present embodiment, pixel values of a plurality of pixels neighboring to the target pixel are corrected (step S13, S16, or S19). According to this configuration, deterioration in image quality due to the change in the pixel value of the target pixel can be minimized.

Also, according to the present embodiment, the pixel value of the target pixel is changed when the pixel value of the target pixel is greater than or equal to a predetermined threshold value (step S12, S15, or S18 when the determination result in step S11, S14, or S17 is “YES”). According to this configuration, the pixel value can be changed only when the burn-in prevention effect is relatively high.

Also, the embodiment of the present invention is not limited to the above embodiments and can be modified, for example, as follows. That is, although pixel values of a maximum of three sub-pixels (a target R pixel, a target G pixel, and a target B pixel) are changed for each frame in the example of the operation shown in FIG. 5, a pixel value of any one sub-pixel (the target R pixel, the target G pixel, or the target B pixel) may be changed.

Also, although one pixel is randomly selected as a target pixel in one frame in the example of the operation shown in FIG. 5, a pseudo-random number signal may be generated a plurality of times in one frame and a plurality of pixels may be selected as target pixels on the basis of a plurality of pseudo-random number signals and pixels values of the plurality of pixels may be changed.

Also, although four pixels neighboring to the target pixel are set as the neighboring pixels in the example shown in FIG. 4, for example, the number of neighboring pixels is set to two above and below the target pixel, two on the left and right of the target pixel, eight above and below the target pixel, on the left and right of the target pixel, and on the left and right diagonals of the target pixel, one above or below the target pixel, or one on the right or left of the target pixel. Also, in changing the pixel value of the target pixel or correcting the pixel values of the neighboring pixels, the pixel value may be decreased or increased by multiplying the pixel value by a predetermined coefficient. Also, the comparison process in steps S11, S14, and S17 may be omitted and the pixel value change process may be executed with respect to all selected target pixels. Also, the process of correcting pixel values of the neighboring pixels in steps S13, S16, and S19 may be omitted.

As described above, the present embodiment can provide a screen saver function while displaying the image on the image display device 1 (hardware) side. Also, pixel values are randomly changed in a place pixel by pixel for each image display period (one frame). It becomes difficult for the viewer to notice the change in the pixel value by generating random coordinates in the H and V directions of the image display and eliminating regularity. Also, although the display color changes when the pixel is changed, the change can be obscured by performing interpolation display on data of the neighboring pixels. Also, in the present embodiment, it is not necessary to save data of a previous frame and compare the data and it is possible to prevent the burn-in with a simple circuit configuration.

Also, in the image display device 1 of the present embodiment, for example, in the case of the full HD display (1920×1080), it is necessary to rewrite pixel values of 2,073,600 pixels to change pixel values of all pixels. When an image display period (1 frame) is 120 Hz, a pixel value can be rewritten every 1/120 seconds. For example, a time period of 2,073,600/120=17,280 seconds=288 minutes=4.8 hours is required to rewrite pixel values of 2,073,600 full HD pixels. However, if pixel values are changed in units of pixels at one of a plurality of locations for each frame, a time period required for rewriting can be shortened. For example, the number of pixels whose pixel values are to be changed at one time can be arbitrarily determined according to an appearance such as a display size.

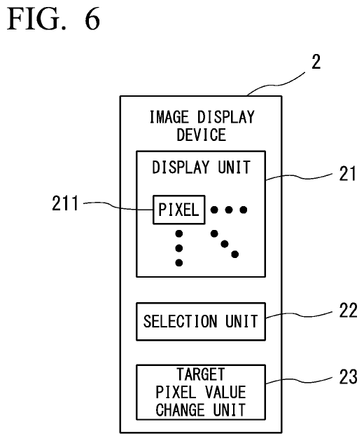

Next, an example of a basic configuration of the image display device according to the embodiment of the present invention will be described with reference to FIG. 6. FIG. 6 is a block diagram showing an example of a basic configuration of the image display device 2 according to the embodiment of the present invention.

The image display device 2 shown in FIG. 6 includes a display unit 21, a selection unit 22, and a target pixel value change unit 23. The display unit 21 has a plurality of pixels 211. The selection unit 22 randomly selects one or more pixels 211 as target pixels from the plurality of pixels 211 for each frame. The target pixel value change unit 23 changes the pixel values of the one or more target pixels selected by the selection unit 22. According to the image display device 2 shown in FIG. 6, because the pixel values of the target pixels randomly selected in units of pixels for each frame are changed, it is possible to prevent burn-in from occurring without giving a sense of discomfort to the viewer.

Also, for example, the image display device 2 shown in FIG. 6 can be modified as follows. That is, the image display device 2 may further include a neighboring pixel value correction unit that corrects pixel values of one or more pixels 211 neighboring to the target pixel. According to the configuration in this modified example, the change in the pixel value of the target pixel can be made inconspicuous by correcting the pixel values of the neighboring pixels.

Also, for example, the image display device 2 shown in FIG. 6 can be modified as follows. That is, the target pixel value change unit 23 may change a pixel value of a target pixel when the pixel value of the target pixel is greater than or equal to a predetermined threshold value. According to this configuration, a change in the pixel value can be limited to a case in which a degree of influence on the burn-in is high and the pixel value is greater than or equal to the predetermined threshold value.

Also, the selection unit 22 may select one or more pixels 211 as target pixels on the basis of an output of the linear feedback shift register. According to this configuration, the target pixels can be randomly selected with a simple configuration.

Also, the target pixel value change unit 23 can change the pixel values of the target pixels to black data. According to this configuration, a better burn-in prevention effect can be obtained.

Also, corresponding relationships between the configuration shown in FIG. 6 or a modified example thereof and the configurations shown in FIGS. 1 to 5 are as follows. That is, the image display device 2 shown in FIG. 6 corresponds to the image display device 1 shown in FIG. 1. The display unit 21 shown in FIG. 6 corresponds to the video signal display unit 14 shown in FIG. 1. The pixel 211 shown in FIG. 6 corresponds to the pixel 150, the R pixel PR, the G pixel PG, or the B pixel PB shown in FIG. 4, or the like. The selection unit 22 shown in FIG. 6 corresponds to the video processing circuit 12 shown in FIG. 1 that executes the processing of step S10 shown in FIG. 5. The target pixel value change unit 23 shown in FIG. 6 corresponds to the video processing circuit 12 shown in FIG. 1 that executes the processing of step S12, S15, or S18 shown in FIG. 5. Also, the neighboring pixel value correction unit in the modified example of the configuration shown in FIG. 6 corresponds to the video processing circuit 12 shown in FIG. 1 that executes the processing of step S13, S16, or S19 shown in FIG. 5.

Although embodiments of the present invention have been described above in detail with reference to the drawings, specific configurations are not limited to the embodiments and other designs and the like may be made without departing from the scope of the present invention.

### REFERENCE SIGNS LIST

1, 2 Image display device
11 Random number generation circuit
12 Video processing circuit
13 Video signal retention circuit
14 Video signal display unit
21 Display unit
22 Selection unit
23 Target pixel value change unit
110 Linear feedback shift register

1. An image display device comprising:
a display comprising a plurality of pixels;
a selector configured to randomly select one or more pixels as target pixels from the plurality of pixels for each frame; and
a target pixel value changer configured to change pixel values of one or more target pixels selected by the selector.

2. The image display device according to claim 1, the image display device further comprising:
a neighboring pixel value corrector configured to correct pixel values of one or more pixels neighboring to the target pixel.

3. The image display device according to claim 1,
wherein the target pixel value changer is configured to change the pixel value of the target pixel when the pixel value of the target pixel is greater than or equal to a predetermined threshold value.

4. The image display device according to claim 1,
wherein the selector is configured to select the one or more pixels as the target pixels on the basis of an output of a linear feedback shift register.

5. The image display device according to claim 1,
wherein the target pixel value changer is configured to change the pixel value of the target pixel to black data.

6. An image display method comprising:
using a display comprising a plurality of pixels;
randomly selecting, by a selector, one or more pixels as target pixels from the plurality of pixels for each frame; and
changing, by a target pixel value changer, pixel values of one or more target pixels selected by the selector.
